(19) United States
(12) Patent Application Publication
(10) Pub. No.: US 2003/0090246 A1
(43) Pub. Date: May 15, 2003

(54) DC-DC converter with current control

(76) Inventors: Krishna Shenai, Naperville, IL (US); Siamak Abedinpour, Chandler, AZ (US)

Correspondence Address: Robert J. Irvine III, McDonnell Boehnen Hulbert & Berghoff, 32nd Floor, 300 S. Wacker Drive, Chicago, IL, 60606, US

(21) Appl. No.: 10/289,115

(22) Filed: Nov. 5, 2002

Related U.S. Application Data
(60) Provisional application No. 60/337,479, filed on Nov. 5, 2001.
(60) Provisional application No. 60/338,479, filed on Dec. 4, 2001.

(51) Int. Cl. G05F 1/24

(52) U.S. Cl. 323/259

(57) ABSTRACT

A direct current voltage converter in accordance with the invention includes a substantially static direct current voltage source, an inductor; a current-control switch coupled with, and between, the voltage source and the inductor, a step-up switch coupled with the inductor, and a current sense device coupled in series with the step-up switch and electrical ground. The converter also includes a capacitor for storing converted voltage that is coupled with, and between, electrical ground, and the inductor and the step-up switch through a device for controlling current flow direction. The converter further includes a first control circuit, which opens and closes the current-control switch based, at least in part, on an electrical current conducted through the current sense device, and a second control circuit, which opens and closes the step-up switch based, at least in part, on a voltage potential across the electrical load.

### PRIORITY AND RELATED APPLICATIONS

The present patent application claims priority under 35 U.S.C. §19(e) to U.S. Provisional Patent Application Serial No. 60/337,479 entitled “Monolithic DC-DC Converter with Current Control for Improved Performance”; filed on Nov. 5, 2001, the full disclosure of which is incorporated herein by reference.

The following references to non-provisional patent applications are also incorporated by reference herein:

“DC-DC Converter with Resonant Gate Drive” to Shenai et al., Attorney Docket No. 02,795-A, filed concurrently herewith;

“Monolithic Battery Charging Device” to Shenai et al., Attorney Docket No. 02,796-A, filed concurrently herewith; and

“Synchronous Switched Boost and Buck Converter” to Shenai et al., Attorney Docket No. 02,1184, filed concurrently herewith.

### FIELD OF INVENTION

The present invention relates to power converters and, more specifically, to direct current to direct current voltage converters (DC-DC converters) with current control.

### BACKGROUND

Direct-current to direct current voltage converters (DC-DC converters) are used frequently in electrical and electronic systems to convert one voltage potential to another voltage potential. Such DC-DC converters typically have some form of regulation that controls an output voltage for the DC-DC converter as the electrical power consumed by an electrical load connected with the DC-DC converter changes. Such loads may include microprocessors, wireless communication devices, or any other electronic system or component that uses a DC voltage. Two common type of DC-DC converter may be referred to as boost and buck converters. Boost converters, as the term indicates, boost an input voltage to provide a higher voltage potential output voltage, relative to the input voltage. Conversely, buck converters reduce an input voltage to produce a lower output voltage, relative to the input voltage.

One challenge that is faced when designing DC-DC converters, such as boost and buck converters, is the efficiency of such converters. Efficiency may be measured by the ratio of output power to input power. Therefore, efficiency for a given DC-DC converter indicates the amount of power consumed, or lost, as a result of the conversion from the input voltage potential to the output voltage potential. Current approaches for implementing DC-DC converters may have efficiencies on the order of sixty-five percent. As electrical and electronic systems continue to increase in complexity, such power losses due to voltage conversion may present more significant design challenges. Therefore, alternative approaches for DC-DC converters may be desirable.

### SUMMARY

A direct current voltage converter in accordance with the invention includes a substantially static direct current voltage source, an inductor; a current-control switch coupled with, and between, the voltage source and the inductor, a step-up switch coupled with the inductor, and a current sense device coupled in series with the step-up switch and electrical ground. The converter also includes a capacitor for storing converted voltage that is coupled with, and between, electrical ground, and the inductor and the step-up switch through a device for controlling current flow direction. The converter further includes a first control circuit, which opens and closes the current-control switch based, at least in part, on an electrical current conducted through the current sense device, and a second control circuit, which opens and closes the step-up switch based, at least in part, on a voltage potential across the electrical load.

### BRIEF DESCRIPTION OF THE DRAWINGS

The subject matter regarded as the invention is particularly pointed out and distinctly claimed in the concluding portion of the specification. The invention, however, as to both organization and method of operation, together with features and advantages thereof, may best be understood by reference to the following detailed description when read with the accompanying drawings in which:

FIG. 1 is a schematic drawing illustrating a prior art direct current to direct current voltage converter (DC-DC converter);

FIG. 2 is a schematic drawing illustrating an embodiment of a DC-DC boost converter with current control in accordance with the invention;

FIG. 3 is a schematic drawing illustrating another embodiment of a DC-DC boost converter in accordance with the invention;

FIG. 4 is a block diagram illustrating an embodiment of a control/startup circuit in accordance with the invention;

FIG. 5 is a block diagram illustrating another embodiment of a control/startup circuit in accordance with the invention; and

FIG. 6 is a schematic drawing illustrating an embodiment of a DC-DC buck converter in accordance with the invention; and

FIG. 7 is a schematic diagram illustrating an embodiment of a control circuit in accordance with the invention.

### DETAILED DESCRIPTION

In the following detailed description, numerous specific details are set forth in order to provide a thorough understanding of the invention. However, it will be understood that the present invention may be practiced without these specific details. In other instances, well-known methods, procedures, components and circuits have not been described in detail, so as not to obscure the present invention.

As was previously indicated, current approaches for implementing a boost converter may have efficiencies in the range of sixty-five percent. Such efficiencies may create significant design challenges in certain applications, such as, for example, monolithic direct current to direct-current voltage converters (DC-DC converter) integrated on a semiconductor device with other circuitry. Such challenges may include power consumption, circuit element sizes for such DC-DC converters, among other issues.

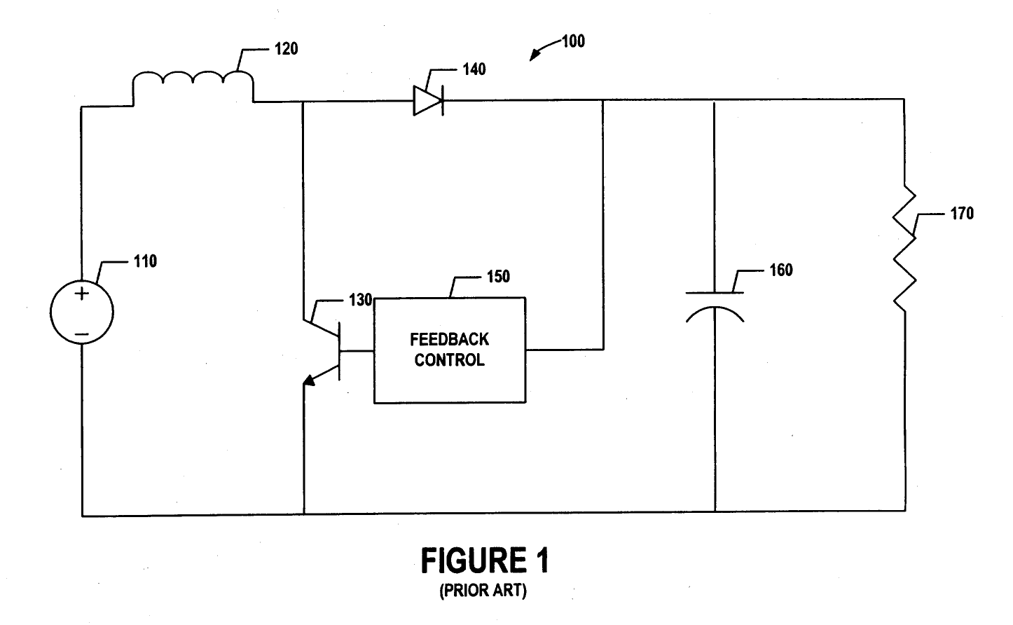

FIG. 1 is a schematic diagram that illustrates a prior art DC-DC boost converter 100 (hereafter “boost converter”), which illustrates some of the foregoing concerns. Boost converter 100 comprises a static direct current voltage source 110. The positive terminal of voltage source 110 is coupled with one terminal of an inductor 120. The other terminal of inductor 120 is coupled with a collector of an npn-type bipolar junction transistor (BJT) 130 and the anode of diode 140. Diode 140 acts as a voltage rectifying device in that diode 140 controls the direction of current flow from inductor 120 in converter 100. The cathode of diode 140 is coupled with an input terminal of feedback control circuit 150, one terminal of capacitor 160 and one terminal of a load resistance 170. The emitter of BJT 130 and the second terminals of capacitor 160 and load resistance 170 are coupled with electrical ground, as illustrated. An output terminal of feedback control circuit 150 is coupled with the base of BJT 130. Feedback control circuit 150 typically regulates the voltage across capacitor 160 and load resistance 170 using a pulse-width modulated or pulse-frequency modulated circuit to turn BJT 130, which may be termed the step-up switch, on and off. It will be appreciated that load resistance 170 may be merely illustrative and representative of a time varying impedance being powered by boost converter 100.

In operation, boost converter 100 accomplishes a step-up voltage conversion in the following manner. This description assumes that boost converter 100 is powered off and no initial voltage potentials are present in the circuit. BJT 130 may be turned on so that it conducts current, which may be referred to as closing the step-up switch. When BJT 130 is turned on, the voltage potential of voltage source 110 will appear across inductor 120. This voltage potential causes a current to ramp up through inductor 120. Subsequently, BJT 130 may be turned off. Turning BJT 130 off causes the voltage across inductor 120 to reverse, resulting in a higher voltage to be present at the anode of diode 140. The resulting voltage depends on the amount of time BJT 130 is turned on. Equations for determining such voltages are known, and will not be discussed here.

As a result of the voltage reversing across inductor 120, the voltage present at the anode of diode 140 is typically higher than the voltage supplied by input voltage source 110. This may be termed the stepped up voltage. The stepped up voltage may then be applied to capacitor 160 and load resistance 170 via diode 140. The voltage across capacitor 160 and load resistance 170 may be compared with a reference signal by feedback control circuit 150. The reference signal may be a pulse train, as in the case of pulse-width modulation control, or may be a reference voltage, as in the case of clocked pulse-frequency modulation control.

When the voltage across capacitor 160 and load resistance 170 exceeds a desired value, feedback control circuit 150 may turn BJT 130 on. In this situation, as was previously indicated, diode 140 functions so as to rectify the stepped-up voltage during conversion, thereby preventing capacitor 160 from discharging through BJT 130. This allows the voltage potential stored on capacitor 160 to be discharged into load resistance 170. Likewise, when the voltage across capacitor falls below the desired level, feedback control circuit 150 may turn off BJT 130 (open the step-up switch), which allows electrical energy stored in inductor 120 to be transferred to capacitor 160 and load resistance 170.

However, boost converter 100 suffers from at least some of the previously discussed disadvantages. For example, as the impedance of load resistance 170 decreases, the efficiency of boost converter 100 may also decrease. In this regard, because less electrical energy would be transferred from inductor 120 to capacitor 160 and load resistance 170 at lower load resistances, the on (closed) time of BJT 130 accordingly increases. This increase in the on time of BJT 130 may result in the current through inductor 120 rising to values that cause the inductor to saturate and, as a result, dissipate, rather than store electrical energy. This dissipated electrical energy directly affects (reduces) the efficiency of boost converter 100. Therefore, based on the foregoing, alternative approaches for power conversion may be desirable.

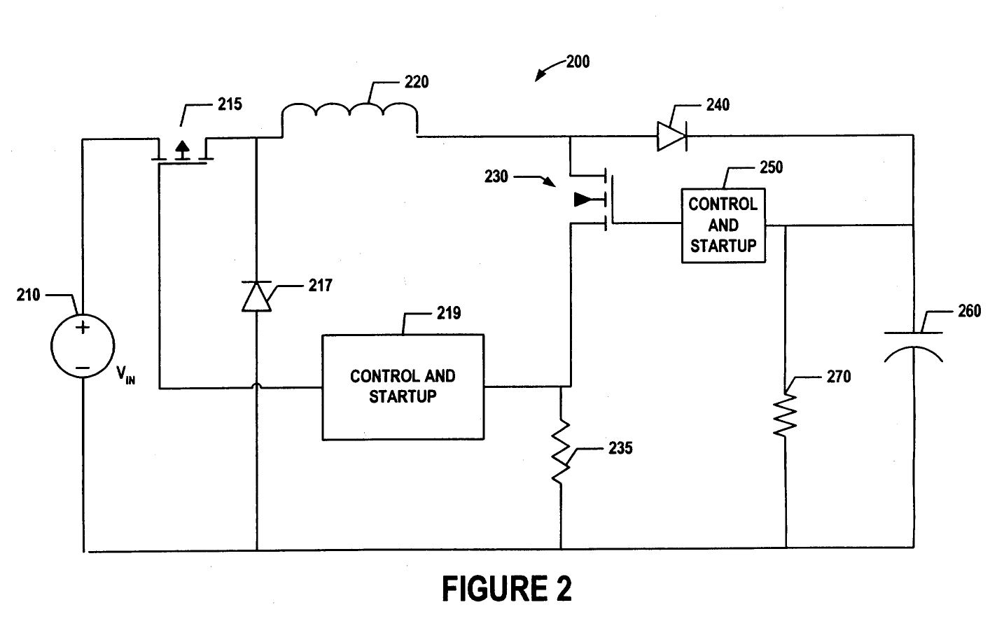

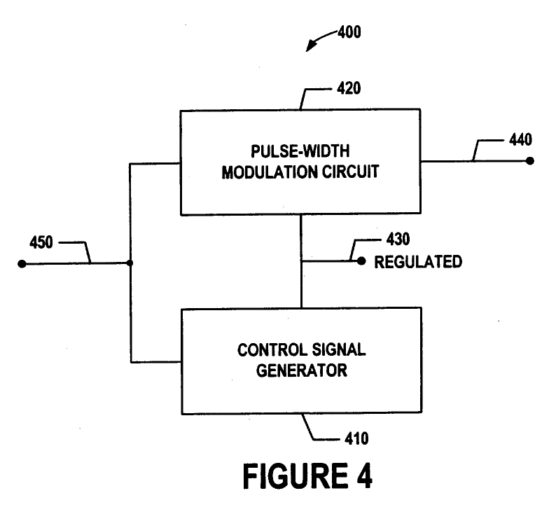

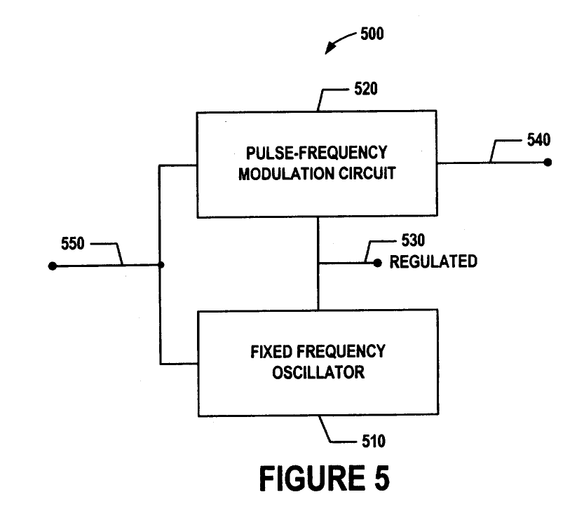

FIG. 2 is a schematic diagram illustrating an embodiment of a boost converter 200 with current control according to the invention, which overcomes at least some of the foregoing disadvantages of current approaches. For this particular embodiment, boost converter 200 comprises a substantially static direct current voltage source 210 and an inductor 220. A current-control switch 215 is coupled with, and between, the positive terminal of voltage source 210, and a first terminal of inductor 220. For boost converter 200, current control switch 215 takes the form of a p-type field effect transistor (FET). As may be seen in FIG. 2, the gate of current-control switch 215 is coupled with control/startup circuit 219. Such control/startup circuits, and their interaction with current-control switch 215, will be discussed in more detail below with reference to boost converter 200, and further with reference to FIGS. 4 and 5.

Boost converter 200 further comprises a step-up switch 230 coupled with a second terminal of inductor 220. For this particular embodiment, step-up switch 230 takes the form of an n-type (FET), where the gate of the n-type FET is coupled with a second control/startup circuit 250. Again, such control/startup circuits are discussed more detail hereinafter. Step-up switch 230 is further coupled with a current sense device 235. For boost converter 200, current sense device 235 takes the form of a resistive device and is coupled in series with step-up switch 230 between the second terminal of inductor 220 and electrical ground.

Boost converter 200 additionally comprises current flow direction control devices, which, for this embodiment, take the form of pn-junction diodes 217 and 240. Diode 217 is coupled with the first terminal of inductor 220 and electrical ground. The anode of diode 240 is coupled with the second terminal of inductor 220 and the drain of step-up switch 230, while the cathode is coupled with one terminal each of capacitor 260 and load resistance 270. Capacitor 260 functions as a filtering cap to reduce ripple in the converted voltage supplied to load resistance 270, as well as function as a charge storage device for voltage converted by converter 200. Load resistance 270 is representative of any device that may be powered by a DC-DC converter in accordance with the invention and should be viewed as an impedance, not a pure resistive element. Also, load resistance 270 may vary over time, which would result in the amount of power being converted by boost converter 200 to also vary over time.

Boost converter 200 may be more efficient than previous boost converter configurations due, at least in part, to the operation of current-control switch 215. In this regard, control/startup circuit 219 may control the state (open or closed) of current-control switch 215 based on the amount of current being conducted by step-up switch 230. For boost converter 200, control/startup circuit 219 may sense this current by sensing a voltage drop across current sense device 235. If the sensed current is below a threshold value (e.g. a current near the saturation current for inductor 220) current-control switch would remain on.

However, if the sensed current is above the threshold value, control/startup circuit 219 may open current-control switch 215. Opening current-current control switch 215 disconnects voltage source 210 from inductor 220, which may result in a reduction of power consumed, as inductor 220 would not current saturate and dissipate electrical power, as opposed to storing it. In this situation, inductor 220 would either discharge into capacitor 260 and load resistance 270 through diodes 217 and 240, or free-wheel through diode 217, step-up switch 230, and current sense device 235. The particular current path depends on the state (open or closed) of step-up switch 230.

In this regard, control/startup circuit 250 may control the state of step-up switch 230 by sensing a voltage potential across capacitor 260 and load resistance 270. If the sensed voltage is above a desired value (e.g. the desired regulated voltage), control/startup circuit 250 would close step-up switch 230, allowing capacitor 260 to discharge into load resistance 270. Conversely, if the sensed voltage is below the desired value, control/startup circuit 250 would open step-up switch 230, allowing inductor 260 to discharge into capacitor 260 and load resistance 270, resulting in the voltage potential across capacitor 260 and load resistance 270 being increased until such time that control/startup circuit closes step-up switch 230, such as in the manner just described. Boost converter 200, to effect voltage regulation for load resistance 270, would continuously repeat such a cycle.

Boost converters, such as boost converter 200, also typically include a startup circuit for initializing the boost converter from a powered-off state to a regulated, powered-on state. In this regard, both control/startup circuit 219 and control/startup circuit 250 may comprise such startup circuits. Two such approaches are discussed below with reference to FIGS. 4 and 5.

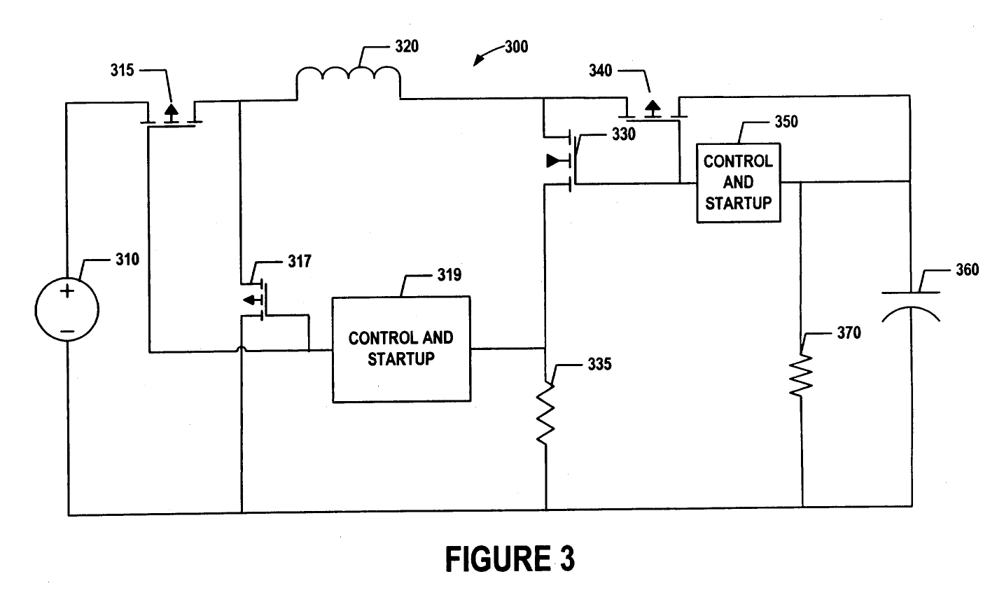

FIG. 3 is a schematic diagram illustrating another embodiment of boost converter 300 according to an embodiment of the invention. Boost converter 300 is similar in configuration to boost converter 200 depicted in FIG. 2. For the purposes of brevity, only the differences between boost converter 200 and boost converter 300 will be discussed with respect to FIG. 3. In this regard, boost converter 300 comprises an n-type FET switching device 317 and a p-type FET switching device 340. These devices replace, respectively, diodes 217 and 240 of boost converter 200.

Such a configuration may be advantageous over prior approaches in a number of respects. In this regard, the use of FET devices 317 and 340 may be advantageous as the voltage drop across such devices when they are conducting is typically lower than the voltage drop across a forward biased diode. Also the use of n-type FET 317 and p-type FET 340 may be advantageous over embodiments that employ a single type of FET device (i.e. only n-type or only p-type). In this regard, a single gate drive circuit may be used to control both FET 317 and 340, where embodiments using only n-type or only p-type FETs typically employ two gate drive (control) circuits.

FIGS. 4 and 5 are block diagrams illustrating two embodiments of control/startup circuits (400 and 500) in accordance with the invention. These control/startup circuits may be used for control startup circuits 219 and 250 in boost converter 200, or for the control/startup circuits of boost converter 300, depicted in FIG. 3. Of course, various approaches for such control/startup circuits may be used, and the invention is not limited in scope to the use of any particular techniques. In this respect, the following discussion is provided by way of example.

Control/startup circuit 400, as shown in FIG. 4, comprises a control signal generator 410. Control signal generator 410 may close a current-control switch (or a step-up switch), such as previously described, to initialize a boost converter from a powered-off state to a regulated, powered-on state. This may be termed a startup state for such a boost converter. In such embodiments, control signal generator 410 may then be disabled once the boost converter is in the regulated, powered-on state.

Control startup circuit 400 may further comprise a pulse-width modulated (PWM) circuit 420. Such PWM circuits are known and will not be described in detail here. PWM circuit 420 may provide an indication that a boost converter, such as boost converter 300, is in a regulated, powered-on state using signal line 430. Alternatively, this indication may be provided from a circuit external to control/startup circuit 400. Such a signal on line 430 may indicate to control signal generator 410 that the boost converter is in the regulated, powered-on state, resulting in control signal generator 410 being disabled.

In a similar respect, an input signal line 440 may be used to communicate current sense information, or regulated output voltage information to control startup circuit 400 when a voltage converter, such as boost converter 300, is in the regulated, powered-on state. Signal generator 410 and PWM circuit 420 may use output signal line 450 to communicate signals that control the state (open or closed) of a current-switch or a step-up switch when boost converter 300 is in, respectively, the startup state and the regulated, powered-on state.

Control/startup circuit 500, as shown in FIG. 5, comprises a fixed frequency oscillator 510. Fixed frequency oscillator 510 may open and close a current-control switch (or a step-up switch), such as previously described, to initialize a boost converter from a powered-off state to a regulated, powered-on state (the startup state). Fixed frequency oscillator 510 may then be disabled once the boost converter is in the regulated, powered-on state.

Control/startup circuit 500 may further comprise a pulse-frequency modulated (PFM) circuit 520. Such circuits are known and will not be described in detail here. PFM circuit 520 may provide an indication that a boost converter is in a regulated, powered-on state via signal line 530. Alternatively, this indication may be provided from a circuit external to control/startup circuit 500. The signal on line 530 may indicate to fixed frequency oscillator 510 that the boost converter is in the regulated, powered-on state, resulting in fixed frequency oscillator 510 being disabled.

In a similar respect as was discussed with respect to FIG. 4, an input signal line 540 may be used to communicate current sense information, or regulated output voltage information to control startup circuit 500 when a voltage converter, such as boost converter 300, is in the regulated, powered-on state. Fixed frequency oscillator 510 and PFM circuit 520 may use output signal line 550 to communicate signals that control the state (open or closed) of a current-switch or a step-up switch when, for example, boost converter 300 is in, respectively, the startup state and the regulated, powered-on state.

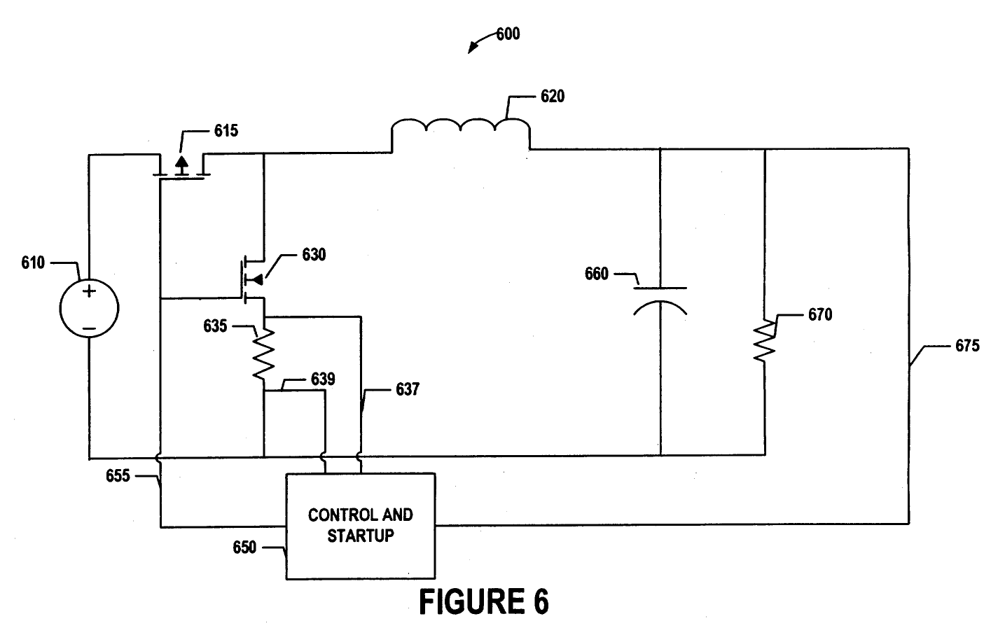

FIG. 6 is a schematic diagram that illustrates an embodiment of a buck converter 600 in accordance with the invention. For this particular embodiment, buck converter 600 comprises a substantially static direct current voltage source 610 and an inductor 620. A current-control switch 615 is coupled with, and between, the positive terminal of voltage source 610, and a first terminal of inductor 620. For buck converter 200, current control switch 615 takes the form of a p-type FET, as has been previously described with respect to the boost converters shown in FIGS. 2 and 3.

Buck converter 600 further comprises a switching device 630, which for this embodiment takes the form of an n-type FET. Switching device 630 is coupled with current-control switch 615 and inductor 620. Switching device 630 is further coupled with a current sense resistor 635, which is also coupled with electrical ground. As will be described further below, current sense resistor 635 may be used to determine an amount of current conducted through switching device 630 and, based on that current, effect current control for buck converter 600.

Buck converter 600 also comprises a capacitor 660 and a load resistance 670. Load resistance 670 may be a time varying impedance for which converter 600 supplies electrical energy. Capacitor 660 may provide ripple control for the output voltage of converter 600, as well as charge storage, to supply electrical energy for transient changes in power requirements of load resistance 670.

Converter 600 additionally comprises a control circuit 650, which is coupled with current sense resistor 635, capacitor 660, load resistance 670, and gates of current-control switch 615 and switching device 630. Based on the current across current sense resistor 635 (which may be communicated via signal lines 637 and 639) and the voltage potential present on capacitor 660 and load resistance 670 (which may be communicated via signal line 675), control circuit 650 may effect voltage conversion and current control for converter 600 via signal line 655.

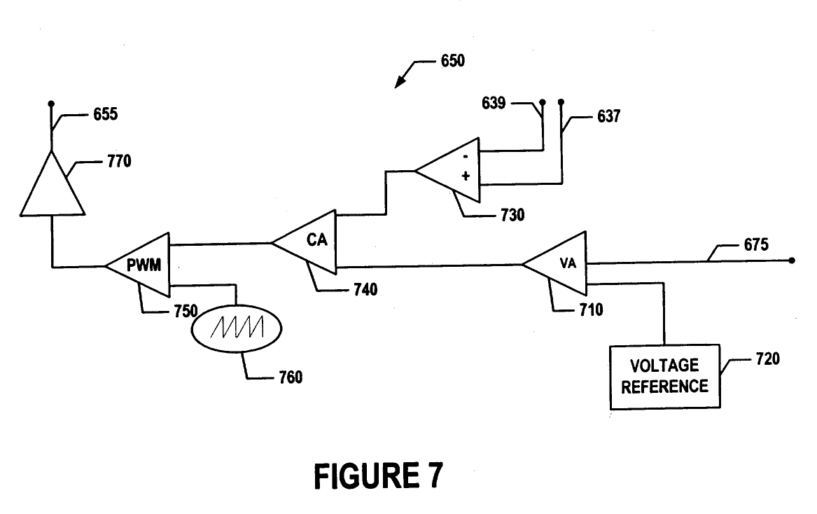

In this regard, FIG. 7 is a schematic diagram that illustrates an embodiment of a control circuit 650 in accordance with the invention. It will be appreciated that the invention is not limited in scope to this particular embodiment and other configurations for control circuit 650 are possible. For the embodiment shown in FIG. 7, control circuit 650 comprises a voltage amplifier 710. Voltage amplifier 710 is coupled with signal line 675 and a voltage reference 720. Voltage reference 720 communicates a voltage potential that represents a desired output voltage for converter to voltage amp 710. Voltage amp 710 then compares the output voltage potential of converter 600 (communicated via signal line 675) with the reference voltage potential. Based on that comparison, voltage amp 710 may generate a signal that indicates whether the output voltage potential is too low or too high.

Control circuit 650, as depicted in FIG. 7, also includes a comparator 730 that is coupled with signal lines 637 and 639 to determine the current flowing through current sense resistor 635 of converter 600. In this respect, based on the voltage differential between the signals on signal lines 637 and 639, comparator 730 may produce a signal that represent the amount of current flowing through current sense resistor 730.

The signals produced by voltage amp 710 and comparator 730 may then be compared by a current amplifier 740. Current amplifier 740, based on the comparison of those signals, may produce an output signal that is communicated to a PWM circuit 750. PWM circuit 750 is also coupled with a signal source 760, which produces a reference signal for PWM circuit 750. For this particular embodiment, PWM circuit 750 would typically have a binary, not a continuous, output signal. Such a configuration may be advantageous as the output of PWM circuit 750 may be used to control current-control switch 615 and switching device 630 to effect voltage conversion and current control for converter 600. As is shown if FIG. 7, the output signal of PWM circuit 750 may be fed through a signal buffer, such as buffer 770. Buffer 770 may provide gain and/or noise immunity for that signal, which may, in turn, improve the performance of converter 600.

While certain features of the invention have been illustrated and described herein, many modifications, substitutions, changes and equivalents will now occur to those skilled in the art. It is, therefore, to be understood that the appended claims are intended to cover all such modifications and changes as fall within the true spirit of the invention.

What is claimed is:

1. A direct current voltage boost converter comprising:
a substantially static direct current voltage source;
an inductor;
a current-control switch coupled with, and between, the voltage source and the inductor;
a step-up switch coupled with the inductor;
a current sense device, coupled in series with the step-up switch and an electrical ground;
a capacitor coupled with, and between, the electrical ground, and the inductor and the step-up switch via a first device for controlling current flow direction;
a first control circuit coupled with the current sense device and the current-control switch, wherein the first control circuit opens and closes the current-control switch based, at least in part, on an electrical current conducted through the current sense device; and
a second control circuit coupled with the electrical load and the step-up switch, wherein the second control circuit opens and closes the step-up switch based, at least in part, on a voltage potential across the capacitor.

2. The boost converter of claim 1, wherein the current-control switch comprises a p-type field effect transistor (FET), and the first control circuit is coupled with a gate of the p-type FET.

3. The boost converter of claim 1, wherein the step-up switch comprises an n-type field effect transistor (FET), and the second control circuit is coupled with a gate of the n-type FET.

4. The boost converter of claim 1, wherein the current sensing device comprises a resistive device and the first control circuit determines the electrical current conducted through the current sensing device by sensing a voltage drop across the resistive device.

5. The boost converter of claim 1, wherein the first device for controlling current flow direction comprises a pn-junction diode.

6. The boost converter of claim 1, wherein the first device for controlling current flow direction comprises a p-type field effect transistor (FET), such that a gate of the p-type FET is coupled with the second control circuit.

7. The boost converter of claim 1, further comprising a second device for controlling current flow direction coupled with, and between, the electrical ground, and the current-control switch and the inductor.

8. The boost converter of claim 7, wherein the second device for controlling current flow direction comprises a pn-junction diode.

9. The boost converter of claim 7, wherein the second device for controlling current flow direction comprises an n-type field effect transistor (FET), such that a gate of the n-type FET is coupled with the first control circuit.

10. The boost converter of claim 1, wherein the first and second control circuits further comprise respective first and second startup circuits for initializing the boost converter from a powered-off state to a regulated, powered-on state.

11. The boost converter of claim 10, wherein the first and second startup circuits comprise fixed frequency oscillators, which are disabled when the boost converter is in the regulated, powered-on state.

12. The boost converter of claim 10, wherein the first startup circuit comprises a control signal generator, which closes the current-control switch to initialize the boost converter from the powered-off state to the regulated, powered-on state and is disabled when the boost converter is in the regulated, powered-on state.

13. The boost converter of claim 1, wherein the first and second control circuits comprise voltage mode pulse-width modulated circuits.

14. The boost converter of claim 1, wherein the first and second control circuits comprise clocked pulse-frequency modulation circuits.

15. A circuit comprising:
a first switching device;
a first device for controlling current flow direction coupled with the first switching device and an electrical ground;
a first electrical energy storage device coupled with the first switching device and the first device for controlling current flow direction;
a second switching device coupled with the first electrical storage device;
a current sense device coupled with the second switching device and the electrical ground;
a second device for controlling current flow direction coupled with the second switching device and the first electrical energy storage device;
a second electrical energy storage device coupled with the second device for controlling current flow direction and the electrical ground;
a first control circuit coupled with the current sense device and the first switching device, wherein the first control circuit opens and closes the first switching device based, at least in part, on an electrical current conducted through the current sense device; and
a second control circuit coupled with the second electrical energy storage device and the second switching device, wherein the second control circuit opens and closes the second switching device based, at least in part, on a voltage potential across the second electrical energy storage device.

16. The circuit of claim 15, wherein the first switching device comprises a p-type field effect transistor (FET), and the first control circuit is coupled with a gate of the p-type FET.

17. The circuit of claim 15, wherein the first device for controlling current flow direction comprises a pn-junction diode.

18. The circuit of claim 15, wherein the first device for controlling current flow direction comprises an n-type field effect transistor (FET), and the first control circuit is coupled with a gate of the n-type FET.

19. The circuit of claim 15, wherein the first electrical energy storage device comprises an inductor.

20. The circuit of claim 15, wherein the second switching device comprises an n-type field effect transistor (FET), and the second control circuit is coupled with a gate of the n-type FET.

21. The circuit of claim 15, wherein the current sense device comprises a resistive device.

22. The circuit of claim 15, wherein the second device for controlling current flow direction comprises a pn-junction diode.

23. The circuit of claim 15, wherein the second device for controlling current flow direction comprises a p-type field effect transistor (FET), and the first control circuit is coupled with a gate of the p-type FET.

24. The circuit of claim 15, wherein the second electrical energy storage device comprises a capacitor.

25. The circuit of claim 15, wherein the first and second control circuits further comprise respective first and second startup circuits that, at least in part, initialize the circuit from a powered-off state to a regulated, powered-on state when coupled with a substantially static, direct current voltage source.

26. The circuit of claim 15, wherein the first and second control circuits comprise, individually, one of a pulse-width modulated circuit and a pulse-frequency modulation circuit.

27. A circuit comprising:
a p-type field effect transistor (FET) current-control switch;
a first device for controlling current flow direction coupled with the current control switch and an electrical ground, wherein the first device for controlling current flow direction comprises one of a rectifying diode and an n-type FET;
an inductor coupled with the current-control switch and the first device for controlling current flow direction;
an n-type FET step-up switch coupled with the inductor;
a resistive current sense device coupled in series with the step-up switch and the electrical ground;
a second device for controlling current flow direction coupled with the step-up switch and the inductor, wherein the second device for controlling current flow direction comprises one of a rectifying diode and a p-type FET;
a capacitor coupled with the second device for controlling current flow direction and the electrical ground;
a first control circuit coupled with the current sense device and a gate of the current-control switch, wherein the first control circuit comprises one of a pulse-width modulation and a pulse-frequency modulation circuit that opens and closes the current-control switch based, at least in part, on a current being conducted through the current sense device; and
a second control circuit coupled with the capacitor and a gate of the step-up switch, wherein the second control circuit comprises one of a pulse-width modulation and a pulse-frequency modulation circuit, that opens and closes the step-up switch based, at least in part, on a voltage potential across the capacitor,
wherein the first and second control circuits further comprise respective first and second startup circuits that initialize the circuit from a powered-off state, to a regulated, powered-on state when the circuit is coupled with a substantially static, direct current voltage source.

28. The boost converter of claim 27, wherein the first and second startup circuits comprise fixed frequency oscillators, which are disabled when the boost converter is in the regulated, powered-on state.

29. The boost converter of claim 27, wherein the first startup circuit comprises a control signal generator, which closes the current-control switch to, at least in part, initialize the boost converter from the powered-off state to the regulated, powered-on state and is disabled when the boost converter is in the regulated, powered-on state.

30. A direct current voltage boost converter comprising:
a substantially static direct current voltage source;
an inductor;
an n-type field effect transistor (FET) step-up switch coupled with the inductor;
a p-type FET coupled with the step-up switch and the inductor;
a capacitor coupled with, and between, the electrical ground, and the inductor and the p-type FET; and
a control circuit coupled with the electrical load, the step-up switch and the p-type FET, wherein the control circuit regulates a voltage potential across the capacitor by opening and closing the step-up switch and the p-type FET one-hundred-eighty degrees out of phase based, at least in part, on the voltage potential across the capacitor.

31. The boost converter of claim 30, wherein the control circuit comprises one of a pulse-width modulation circuit and a pulse-frequency modulation circuit.

32. The boost converter of claim 31, wherein the control circuit further comprises a startup circuit to initialize the boost converter from a powered off state to a regulated, powered-on state.

33. The boost converter of claim 32, wherein the startup circuit comprises a fixed frequency oscillator, which is disabled when the boost converter is in the regulated, powered-on state.

34. A direct current voltage buck converter comprising:
a p-type field effect transistor (FET) current-control switch;
an n-type FET switching device coupled with the current-control switch;
a current sense resistor coupled with the switching device and an electrical ground;
an inductor coupled with the current-control switch and the first switching device;
a capacitor coupled with the inductor and the electrical ground; and
a control circuit coupled with the current sense resistor, the capacitor, and gates of the current-control switch and the switching device, wherein the control circuit comprises:
a voltage amplifier for comparing an output voltage potential of the converter with a reference voltage potential;
a comparator coupled with the current sense resistor so as to determine a current conducted through the current sense resistor;
a current amplifier coupled with output terminals of the voltage amplifier and the comparator, and
a pulse-width-modulated (PWM) circuit coupled with an output terminal of the current amplifier, wherein a binary output signal of the PWM circuit is used to control the p-type FET and the n-type FET during operation of the buck converter.
